(19) United States
(12) Patent Application Publication
(10) Pub. No.: US 2007/0122156 A1
(43) Pub. Date: May 31, 2007

(54) Apparatus, system, and method for interconnecting electrical and electronic signals

(76) Inventors: Tongqing Wang, La Canada Flintridge, CA (US); Jinghui Li, Arcadia, CA (US); Yuanmin Cai, Tenafly, NJ (US)

Correspondence Address: Yuanmin Cai, Apt. A, 74 Demott Street, Tenafly, NJ, 07670, US

(21) Appl. No.: 11/287,587

(22) Filed: Nov. 28, 2005

(51) Int. Cl. H04B 10/12

(52) U.S. Cl. 398/141

(57) ABSTRACT

Embodiments of the present invention provide an apparatus for interconnecting an electrical signal from a first electronic device to a second electronic device. The apparatus includes at least one optical signal path and first and second terminals integrally integrated with the optical signal path. The first and second terminals having respective first and second electrical interfaces and being separated by a distance in a range, up to the length of the optical signal path, adapted to connect the first and second electronic devices at respective first and second locations. The first electrical interface adapted to receive the electrical signal from the first electronic device and to convey the electrical signal to the second terminal via the optical signal path, and the second electrical interface adapted to transfer the electrical signal to the second electronic device. A method for performing the same is also provided.

### FIELD OF THE INVENTION

The present invention relates to apparatus, system, and method for interconnecting electrical and/or electronic signals. In particular, it relates to interconnecting electrical and/or electronic signals using an optical signal path terminated by electrical interfaces.

### BACKGROUND OF THE INVENTION

It is generally known in the art that electrical and/or electronic signals, referred to hereinafter as electrical signals without losing generality, may be conveyed or carried around or shared among multiple electronic devices through electrical cables. It is also known in the art that optical signals or light signals or lights may propagate from one optical device to another optical device through an optical signal path or optical signal transmission medium such as, for example, an optical fiber. The signals, in their electrical or optical forms, may carry information including, for example, audio signal, video signal, and/or data.

An electrical cable used in electrical and electronic device interconnection is usually terminated at opposite ends of the cable by two connectors. The connectors typically have a mating portion with a mating face facing toward a complementary connector attached to the electronic device. An electrical cable in general is easy to use and requires low maintenance and/or no care. In particular, electrical connectors used in connecting or engaging electronic devices are generally considered durable and reliable. Electrical cables, for example cables used in an environment where high signal fidelity and/or wide bandwidth are required, are usually bulky, rigid, heavy, and expensive. Power levels of signals at a receiving end of the cable may vary due to variations of cable losses and, as is known in the art, quality of signals received may fluctuate depending on power levels of the signals. In addition, the quality of signals may suffer from electromagnetic interference the cable carrying the signals may be subjected to. The above cables may be found, for example, in a broadcasting studio and/or some high-end home entertainment systems connecting various electrical signal ports including, for example, from a media center outlet to a high-definition television (HDTV), set-top box, DVD/VCD/VCR players and/or sounds systems. The above cables may also be found in a wireless application such as, for example, in an application where cables are used to interconnect electrical signals between central units of base station and antennas.

Optical cables are generally compact, flexible, light and inexpensive. An optical cable may provide low or almost no loss to optical signals propagating therein, and may be immune to at least some of the electrical interferences that an electrical cable may suffer otherwise. Reliable optical signal interconnection between two optical cables or between an optical cable and an optical device may depend on the good care and diligent maintenance of optical connectors to protect them from potential damage and/or contaminations. Also, it requires paying a close attention to the safety issue of laser light exposure when working with optical cables and optical interconnections.

### BRIEF DESCRIPTION OF THE DRAWINGS

The present invention will be understood and appreciated more fully from the following detailed description of embodiments of the invention, taken in conjunction with the accompanying drawings of which:

FIG. 1 is a block diagram illustration of an interconnected electronic system according to one embodiment of the invention;

FIG. 2 is a schematic illustration of an apparatus of cable arrangement according to one embodiment of the invention;

FIG. 3 is a schematic illustration of an apparatus of cable arrangement according to another embodiment of the invention;

FIG. 4 is a schematic illustration of an apparatus of cable arrangement according to yet another embodiment of the invention;

FIG. 5 is a schematic illustration of an apparatus of cable arrangement according to one another embodiment of the invention;

FIG. 6 is a schematic illustration of an apparatus of cable arrangement according to another embodiment of the invention;

FIG. 7 is a schematic illustration of an apparatus of cable arrangement according to yet another embodiment of the invention;

FIG. 8 is a schematic illustration of an apparatus of cable arrangement according to one another embodiment of the invention;

FIG. 9 is a block diagram illustration of a terminal configuration according to one embodiment of the invention;

FIG. 10 is a block diagram illustration of a terminal configuration according to another embodiment of the invention;

FIG. 11 is a block diagram illustration of a terminal configuration according to yet another embodiment of the invention;

FIG. 12 is a block diagram illustration of a terminal configuration according to one another embodiment of the invention;

FIG. 13 is a block diagram illustration of a terminal configuration according to another embodiment of the invention; and

FIG. 14 is a flowchart illustration of a method for interconnecting an electrical signal between two electronic devices according to one embodiment of the invention;

It will be appreciated that for simplicity and clarity of illustration, elements shown in the figures have not necessarily been drawn to scale. For example, the dimensions of some of the elements may be exaggerated relative to other elements for clarity.

### SUMMARY OF THE INVENTION

Embodiments of the present invention may provide an apparatus for interconnecting an electrical and/or electronic signal from a first electronic device to a second electronic device. The apparatus may include at least one optical signal path having first and second terminals integrally integrated with the optical signal path, the first terminal may have an electrical interface adapted to receive the electrical signal from the first electronic device; the second terminal may have an electrical interface adapted to transfer or couple the electrical signal to the second electronic device; and at least one of the terminals may receive an electrical power supply via one of the electrical interfaces for its operation.

According to one embodiment, the first terminal may include a mechanism or module to convert the electrical signal received from the first electronic device into an optical signal to propagate in the optical signal path, wherein the mechanism or module of converting the electrical signal into the optical signal may include a light source such as, for example, a laser diode (LD), a light emitting diode (LED), or an electro-absorption modulated laser (EML).

According to another embodiment, the second terminal may include a mechanism or module to convert the optical signal received from the optical signal path back into the electrical signal to be transmitted or transferred or coupled to the second electronic device, wherein the mechanism or module of converting the optical signal into the electrical signal may include a photon-detector (PD) such as, for example, a PIN photon-diode (PIN-PD) or an avalanche photon-detector (APD).

According to one embodiment, at least one of the mechanisms or modules may be powered for operation by an electrical power supply or energy received from an external power source via one of the electrical interfaces. According to one embodiment, at least one of the electrical interfaces may be a connectorized interface and may include an electrical connector. According to one embodiment, the optical signal path may be an optical fiber.

Embodiments of the invention may further provide an apparatus having an electrical wire that may carry or convey an electrical power supply or energy from one of the first and second terminals to the other terminal. The electrical wire may run alongside the optical signal path or optical fiber. According to one embodiment of the invention, at least one of the mechanism or modules may be operated by the electrical power supply or energy received via the electrical wire.

According to one embodiment, the electrical interface of the first terminal may be adapted to receive at least first and second electrical signals from the first electronic device, wherein the first terminal may include a mechanism or module to convert the first and second electrical signals received from the first electronic device into first and second optical signals to propagate in the optical signal path.

According to one embodiment, the second terminal may include a mechanism to convert the first and second optical signals received from the optical signal path back into the first and second electrical signals respectively, and the electrical interface of the second terminal may be adapted to transmit or couple or transfer the first and second electrical signals to the second electronic device.

Embodiments of the invention may further provide an apparatus having at least a second optical signal path having a first terminal or end point terminated at the first terminal and a second terminal or end point terminated at a third terminal, wherein the first terminal may include a mechanism to convert the first and second electrical signals received from the first electronic device into first and second optical signals to propagate in the first and second optical signal paths; the second terminal may include a mechanism or module to convert the first optical signal received from the first optical signal path back into the first electrical signal; and the third terminal may include a mechanism to convert the second optical signal received from the second optical signal path back into the second electrical signal.

According to one embodiment, the electrical interface of the second terminal may be adapted to receive a second electrical signal from the second electronic device and convey or carry the second electrical signal to the first terminal, and wherein the electrical interface of the first terminal may be adapted to transmit or couple or transfer the second electrical signal to the first electronic device.

According to one embodiment, the first terminal may include a first mechanism to convert the first electrical signal received from the first electronic device into first optical signal to propagate in the optical signal path; a second mechanism to convert a second optical signal received from the optical signal path into a second electrical signal to be transmitted or coupled or transferred to the first electronic device, and wherein the second optical signal is converted from the second electrical signal received at the second terminal.

Embodiments of the invention may provide a method for interconnecting an electrical signal from a first electronic device to a second electronic device, via one or more electrically terminated optical signal paths, among electrical signal ports of multiple electronic devices. It enables interconnectivity for electrical signals with wide signal bandwidth provided by optical fibers with the durability, reliability, and convenience of electrical connectors.

Embodiments of the present invention may provide an apparatus, a device, and/or a cable arrangement, which may provide functions referred to herein as electrical-signal-through-optical-propagation (E-top), and therefore the cable arrangement may be referred to as an E-top cable or an E-top cable arrangement. The E-top cable or cable arrangement may combine functionalities of that of electrical connectors and fiber optical cables. Embodiments of the invention may employ optical signals that are confined or contained or sealed within an optical signal path, for example, an optical cable of fibers and the optical signals may be converted from, or converted into, electrical signals at their integrally integrated terminals of the E-top cables. Thus, a user applying the E-top cable to interconnecting electrical signals among electronic devices may avoid the risk of being exposed to direct laser light, or may be even not aware the very existence of any optical signals inside the cable arrangement.

Embodiments of the present invention may provide cables, such as E-top cables as described above, which may be flexible and have relatively high signal transfer rates. The E-top cables may include electrical interfaces or connectors adapted for interconnecting, for example, component video, s-video, composite video and audio signals. Such connectors may include, but not limited to, USB connectors, 1394 firewire connectors, S-video connectors, RCA video connectors, VGA cable connectors, RF coaxial cable connectors of BNC type, SMA type, F-type, N-type, and variations thereof. The E-top cable may in addition provide high-performance connection between PCs and, for example, flat panel displays, digital CRT displays, DVD player, projectors, and HDTV. E-top cables may also be adapted to provide high-performance, high-bandwidth interconnection required for video displays. E-top cable may further be used for interconnection among network elements and/or severs, data and/or electronic file storage devices, wireless and/or satellite stations, antennas and/or other applications requiring high-bandwidth and/or high fidelity electrical signal transmissions.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that embodiments of the invention may be practiced without these specific details. In other instances, well-known methods and procedures have not been described in detail so as not to obscure the embodiments of the invention.

Some portions of the detailed description in the following are presented in terms of algorithms and symbolic representations of operations on electrical and/or electronic signals, and optical signals. These algorithmic descriptions and representations may be the techniques used by those skilled in the electrical and electronic engineering and optical communication arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or electronic or optical signals capable of being stored, transferred, combined, compared, converted, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification, discussions utilizing terms such as “processing,”“determining”, “interconnecting”, “transferring”, “conveying”, “coupling”, “receiving” or the like, refer to actions and/or processes of a terminal and/or an optical signal path of a cable arrangement in an interconnected electronic system, or similarly a signal port of an electronic device, that manipulate and/or transform and/or transfer data and/or signals represented as physical, such as electrical and/or electronic, quantities within the terminal and/or optical signal path into other data and/or signals similarly represented as physical quantities within the interconnected system's terminals, including electrical interfaces and electrical-to-optical conversion modules, and electrical and optical signal paths.

In the following description, various figures, diagrams, flowcharts, models, and descriptions are presented as different means to effectively convey the substances and illustrate different embodiments of the invention that are proposed in this application. It shall be understood by those skilled in the art that they are provided merely as exemplary samples, and shall not be constructed as limitation to the invention.

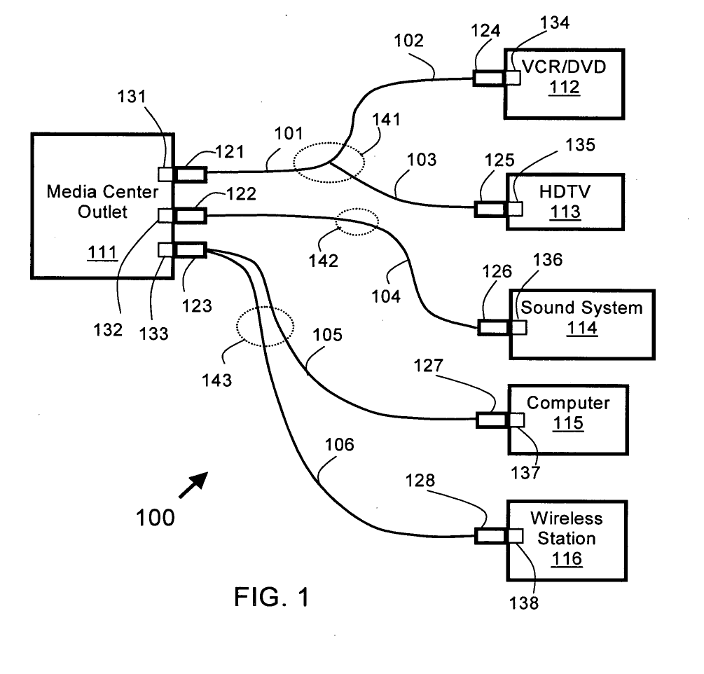

FIG. 1 is a block diagram illustration of an interconnected electronic system according to one embodiment of the invention. System 100 may include a plurality of electronic devices or components or equipments; for example, a media center outlet (111), a VCR/DVD player (112), a High-Definition TV (HDTV) (113), a sound system (114), a computer (115), and a wireless station (116). However, the present invention is not limited in this respect and other types and other numbers of electronic devices or components may be used.

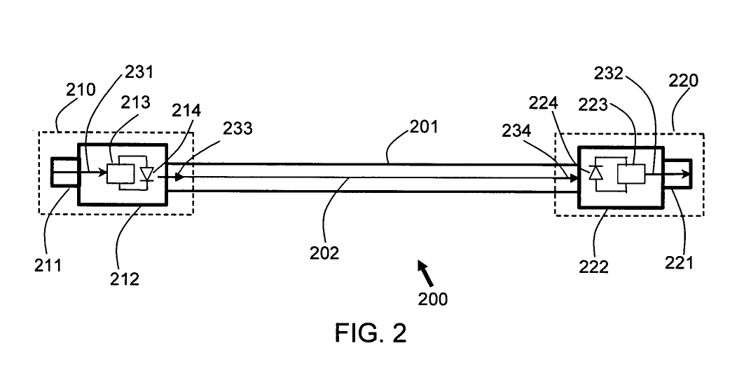

Electronic devices or components 111, 112, 113, 114, 115, and 116 at the same and/or different locations may be connected or interconnected through one or more cables or cable arrangements. For example, cable arrangement 141 may connect devices 111, 112, and 113 together; cable arrangement 142 may connect devices 111 and 114; and cable arrangement 143 may connect devices 111, 115, and 116. Cable arrangements 141, 142, and 143 may be, for example, different embodiments of the present invention as described below in detail with reference to FIGS. 2-8.

According to one embodiment of the invention, cable arrangement 141 may include, for example, cables 101, 102, and 103 connecting to or engaging with devices 111, 112, and 113 through terminals 121, 124, and 125 that may include electrical interfaces. Devices 111, 112, and 113 may be at the same or different locations. Cable 101, 102, and/or 103 may be optical cables of optical fibers. However, the present invention is not limited in this respect and cable 101, 102, and/or 103 may be any types of optical transmission media that provide an optical signal path between terminals. Terminal 121, 124, and 125 may include electrical interfaces that connect to electronic devices 111, 112, and 113 through their electrical signal port 131, 134, and 135. Cable arrangement 142 may include an optical cable 104 connecting devices 111 and 114, at the same or different locations, through their electrical signal ports 132 and 136 at terminals 122 and 126. Cable arrangement 143 may include optical cables 105 and 106 connecting devices 111, 115, and 116, at the same and/or different locations, through their electrical signal ports 133, 137, and 138 at terminals 123, 127, and 128.

Device 111, for example, may transmit an electrical and/or electronic signal, or simply an electrical signal, to device 113. The electrical signal may be sent through signal port 131 to terminal 121. Terminal 121 may convert the received electrical signal into an optical signal, and pass the optical signal through cables 101 and then 103 to terminal 125. Inside terminal 125, the optical signal may be converted back into an electrical signal corresponding to the original electrical signal, and the converted-back electrical signal may be transmitted to, or passed onto, device 113 through signal port 135 of device 113.

In a reversed direction, device 113 may send an electrical signal to terminal 125. The signal received by terminal 125 may be converted into an optical signal to propagate through cable 103 and then cable 101, to reach terminal 121. Inside terminal 121, the optical signal may be converted back into its original electrical signal format and the electrical signal may be passed onto device 111 at signal port 131. Therefore, cable arrangement 141 may be a bi-directional device allowing signals to pass through in both directions.

As is evident from the description above, cable arrangement 141 (similarly for cable arrangements 142 and 143) may be a cable performing electrical-signal-through-optical-propagation (E-top), therefore may be referred to herein as an E-top cable for simplicity.

FIG. 2 is a schematic illustration of an apparatus of cable arrangement according to one embodiment of the invention. Apparatus 200, or device or cable arrangement as may be referred to hereinafter, may include, for example, an optical signal path 201 integrally integrated with two terminals 210 and 220. In other words, the ends of optical signal path 201 may be embedded inside or built into terminals 210 and 220 such that lights or optical signals that are conveyed or transmitted or propagating inside optical signal path 201 may be confined within the apparatus or device or cable arrangement 200 and therefore may not be visible or accessible to a user. For example, a user applying apparatus 200 to interconnect electrical signals between two electronic devices, for example, may not be even aware the existence of optical signals inside apparatus 200. Between terminals 210 and/or 220 and optical path 201, which may be an optical fiber, there may be a protective jacket. The protective jacket may provide, for example, environmental protection such as waterproof for outdoor application of the cable arrangement, and for protection such as micro-bending or cutting to the optical fiber. The protective jacket may be formed to fit around the optical cable and/or terminals. The cable jacket may be made of polyester or any suitable materials.

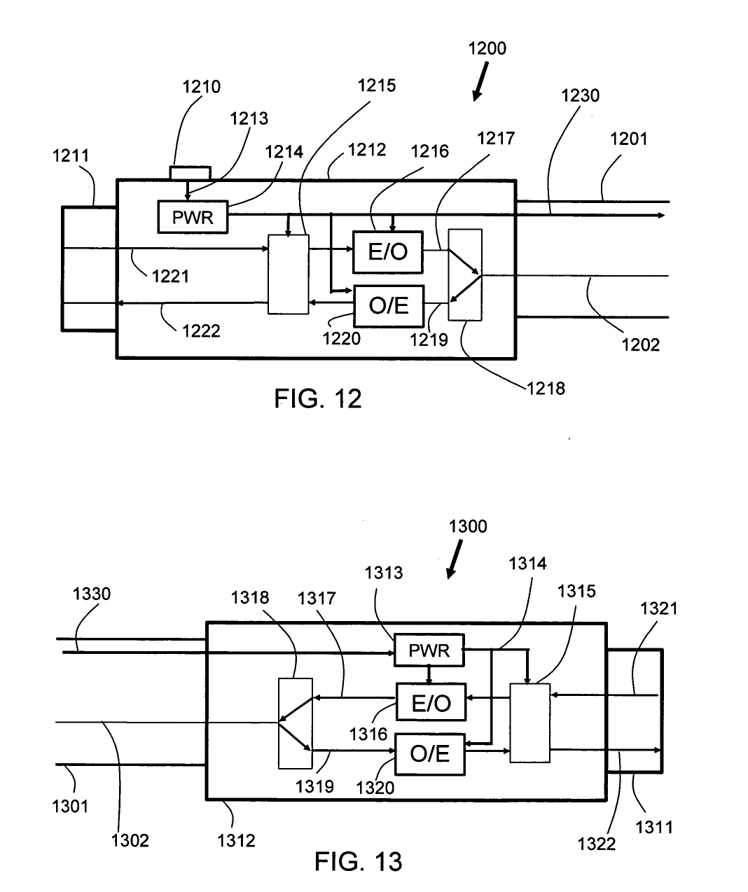

Optical signal path 201, for example, may include an optical cable containing one or more optical fibers, for example, an optical fiber 202. However, the invention is not limited in this respect and other physical media that provide optical signal passage or guide transmission of light therein may be used. For example, optical signal path 201 may include integrated optical circuits (IOC), planar light-wave circuits (PLC), free space, optical lens, mirrors, and/or any combination thereof. Furthermore, according to one embodiment of the invention, an electrical medium such as an electrical wire adapted to convey or carry an electrical power supply for terminals 210 and/or 220 may co-exist, alongside optical signal path 201, with optical fiber 202 as described below in detail with reference to FIGS. 12 and 13.

Terminal 210 may include an electrical-to-optical (E/O) signal conversion module or mechanism 212 attached to an electrical interface 211. However the invention is not limited in this respect and electrical interface 211 may be linked to E/O mechanism 212 via an electrical cable (not shown). Terminal 220 may include an optical-to-electrical (O/E) signal conversion module or mechanism 222 attached to an electrical interface 221. However the invention is not limited in this respect and electrical interface 221 may be linked to O/E mechanism 222 via an electrical cable (not shown). Electrical interfaces 211 and 221 may be connecterized interfaces and as such may include various types of connectors, for example, USB connectors, 1394 firewire connectors, S-video connectors, RCA video connectors, VGA cable connectors, RF coaxial cable connectors of BNC type, SMA type, F-type, N-type, variations thereof, and/or other types of electrical connectors. According to one embodiment, connectors used by interfaces 211 and/or 221 may be adapted to receive an electrical power supply from an external power source.

According to one embodiment, conversion mechanism 212 may include at least one light source 214 such as, for example, laser-diode (LD) or light emitting diode (LED), which converts an electrical signal 231, received from a first electronic device at a first location via interface 211, into an optical signal 233. According to one embodiment, a signal conditioner 213, which may be integrated circuits (ICs) and/or discrete components, may boost the power level and/or reshape input electrical signal 231, among other functions, to drive light source 214. However, the invention is not limited in this respect and input electrical signal 231 may be directly applied to light source 214 to produce optical signal 233, and terminal 210 may not include signal conditioner 213.

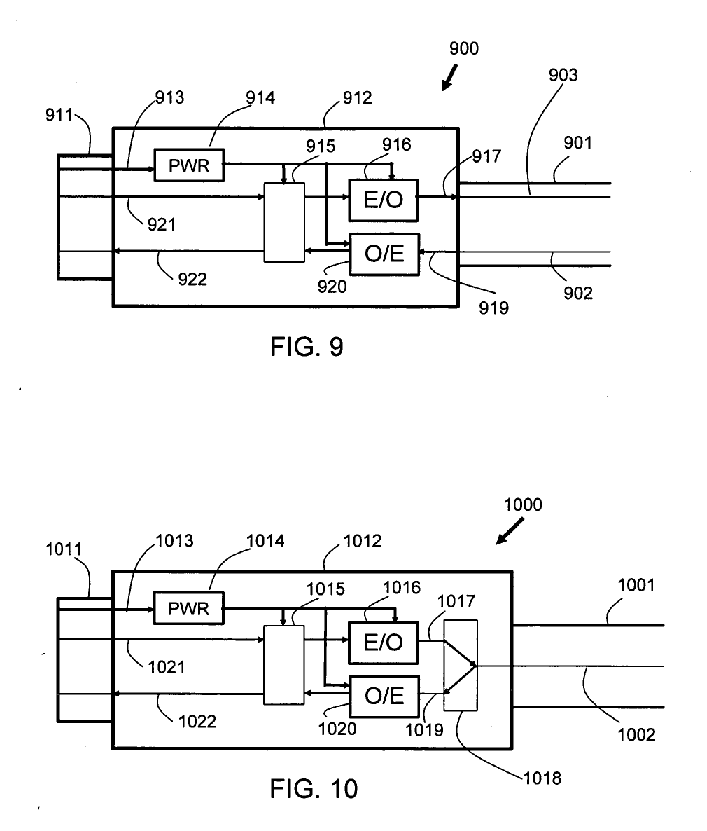

According to one embodiment, conversion mechanism 222 may include at least one photon-detector 224 such as, for example, PIN photon-diode (PIN-PD) or avalanche photon-diode (APD), to convert an optical signal 234 received via optical signal path 201 into an output electrical signal 232. According to one embodiment, a signal conditioner 223 may boost the power level and/or reshape output electrical signal 232 received from photon-detector 224 before electrical signal 232, which corresponds to electrical signal 231, is transferred to a second electronic device at a second location via electrical interface 221. However, the invention is not limited in this respect and electrical signal 232 may be transferred directly to a second electronic device without going through signal conditioner 223. In other words, terminal 220 may not include signal conditioner 223. Configurations of terminals, such as terminals 210 and 220, are described in detail below with reference to FIGS. 9-13.

According to embodiments of the invention, terminals 210 and 220 may be separated by any distance in a range, up to the length of the optical signal path, adapted to connect the first and second electronic devices at respective first and second locations. Terminals 210 and 220 may be at the same place, or may be apart or separated by, for example, three(3) feet, six(6) feet, nine(9) feet, or, for example, by more than twelve (12) feet.

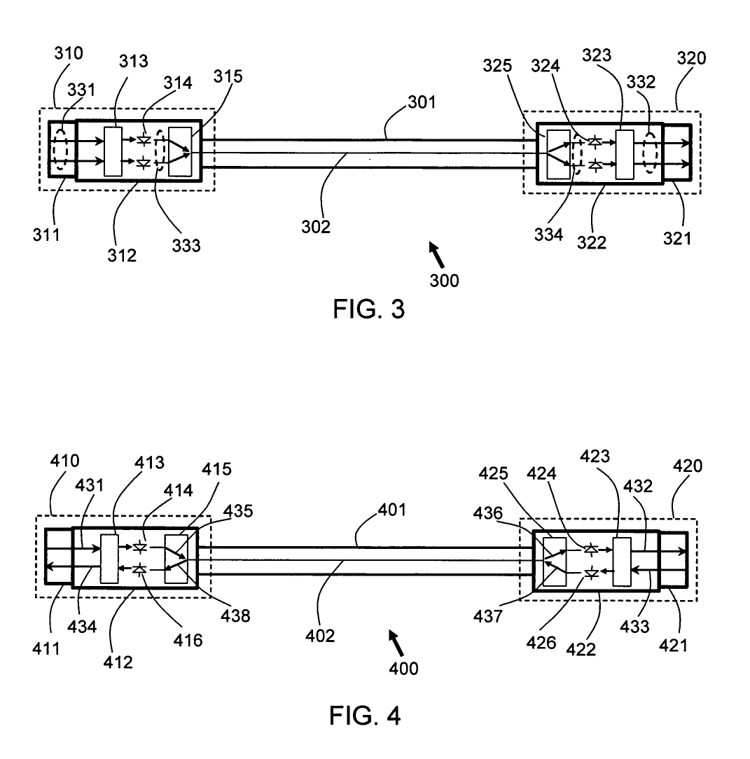

FIG. 3 is a schematic illustration of an apparatus of cable arrangement according to another embodiment of the invention. Apparatus 300, or device or cable arrangement as may be referred to hereinafter, may include an optical signal path 301 integrally integrated at the two end points with terminals 310 and 320. In other words, the end points of optical signal path 301 may be embedded inside or built into terminals 310 and 320 such that lights or optical signals that are conveyed or transmitted or propagating inside optical signal path 301 may be confined within the apparatus or device or cable arrangement 300 and therefore may not be visible or accessible to a user applying apparatus 300 to interconnect electrical signals between two electronic devices. Optical signal path 301 may be, for example, an optical cable having at least one optical fiber 302 but other optical transmission media may be possible. In addition, according to one embodiment of the invention, an electrical medium such as an electrical wire adapted to convey or carry an electrical power supply for use by terminals 310 and/or 320 may co-exist alongside optical signal path 301 with optical fiber 302.

Terminal 310 may include an E/O signal conversion module or mechanism 312 and an electrical interface 311. Terminal 320 may include an O/E signal conversion module or mechanism 322 and an electrical interface 321. Electrical interfaces 311 and 321 may include various types of connectors such as, for example, USB connectors, 1394 firewire connectors, S-video connectors, RCA video connectors, VGA cable connectors, RF coaxial cable connectors of BNC type, SMA type, F-type, N-type, variations thereof and/or other types of electrical connectors. According to one embodiment, connectors used by interfaces 311 and/or 321 may be adapted to receive an electrical power supply from an external power source.

Terminal 310 may receive one or more electrical signals, for example, signals 331, at electrical interface 311 from an external electronic device at a first location (FIG. 1). In other words, electrical interface 311 may couple electrical signals 331 from an external electronic device to E/O conversion module 312. Electrical signals 331 may be converted into one or more optical signals, for example, optical signals 333, inside E/O module 312. According to one embodiment, the conversion may include the use of one or more light sources 314 such as, for example, an array of laser-diodes. A multiplexer 315, for example, may multiplex optical signals 333 into at least one wavelength-division-multiplexing (WDM) signal to propagate along optical fiber 302, for example.

Optical fiber 302 may convey the WDM signal from terminal 310 to O/E module 322 of terminal 320. A de-multiplexer 325 inside O/E module 322, for example, may de-multiplex the WDM signal into one or more optical signals of single wavelength, for example, optical signals 334 that may be converted back into electrical signals, for example, signals 332. According to one embodiment, the conversion may include the use of one or more photon-detectors 324 such as, for example, an array of PIN photon-diodes. According to another embodiment, signal conditioners 313 and 323 may be used to boost power levels of electrical signals 331 and 332 respectively. Electrical signals 332, which correspond to electrical signals 331, may be transferred or coupled to another external electronic device at a second location (FIG. 1) via electrical interface 321. The multiplexing and de-multiplexing of optical signals inside terminals are described in details below with references to FIGS. 9-13.

According to embodiments of the invention, the first and second locations may be at the same place, or may be apart or separated by at least, for example, three(3) feet, six(6) feet, nine(9) feet, or any other desirable distances less than or equal to the length of the optical signal path. For example, the first and second locations may be apart or separated by more than twelve (12) feet.

FIG. 4 is a schematic illustration of an apparatus of cable arrangement according to yet another embodiment of the invention. Apparatus 400, or device or cable arrangement, may include an optical signal path 401 terminated integrally at two terminals 410 and 420. Optical signal path 401 may include, for example, an optical cable having at least one optical fiber 402. However, the present invention is not limited in this respect and other physical media that provide optical transmission support may be used. Furthermore, according to one embodiment of the invention, an electrical medium such as an electrical wire adapted to convey or carry an electrical power supply for terminals 410 and 420 may be included, along optical fiber 401, inside optical signal path 401. However, the invention is not limited in this respect and the electrical wire may run in parallel to optical signal path 401. Apparatus 400 may be used in interconnecting electrical signals among at least two electrical devices.

Terminal 410 may include an electrical interface 411, which may be a connectorized interface, and a module or mechanism 412 for E/O and O/E signal conversion. Terminal 420 may include an electrical interface 421, which may also be a connectorized interface, and a module or mechanism 422 for O/E and E/O signal conversion. According to one embodiment of the present invention, terminal 410 may receive at least one electrical signal, for example, signal 431, from a signal port of an electronic device (FIG. 1) via electrical interface 411. Electrical signal 431 may be converted into an optical signal 435 inside module 412 through modulating a light source 414, which for example may be an LD or LED. Optical signal 435 may then be passed or conveyed or transported by optical signal path 401 to terminal 420.

Additionally, module or mechanism 412 may receive at least one optical signal 438 from optical signal path 401. Optical signal 438 may be converted into an electrical signal 434 inside module 412 by, for example, a photon-detector 416. Photon-detector 416 may be for example a PIN-PD or an APD and other photon-detectors may be used. Electrical signal 434 may be transferred or coupled to the same signal port via the same electrical interface 411 where electrical signal 431 is received. According to one embodiment, a signal conditioner 413, which may be optional, may boost the power levels of input and output electrical signals 431 and 434. According to another embodiment, a multiplexer 415 may multiplex the optical signals 435 and 438 inside module 412 into a bi-directional WDM optical signal.

According to one embodiment of the present invention, terminal 420 may receive at least one electrical signal 433 from a signal port of a second electronic device (FIG. 1) via electrical interface 421. Module 422 inside terminal 420 may convert signal 433 into an optical signal 437, through modulating a light source 426, which for example may be an LD or LED. Optical signal 437 may then be passed or conveyed or transported by optical signal path 401 to terminal 410. Additionally, module or mechanism 422 may receive at least one optical signal 436 from optical signal path 401 and convert optical signal 436 into an electrical signal 432 by, for example, a photon-detector 424. Photon-detector 424 may be for example a PIN-PD or an APD and other photon-detectors may be used. Electrical signal 432 may be transferred or coupled to the same signal port via the same electrical interface 421 where electrical signal 433 is received. According to one embodiment, a signal conditioner 423, which may be optional, may boost the power levels of output and input electrical signals 432 and 433. According to another embodiment, a multiplexer 425 may multiplex the optical signals 436 and 437 inside module 422 into a bi-directional WDM optical signal.

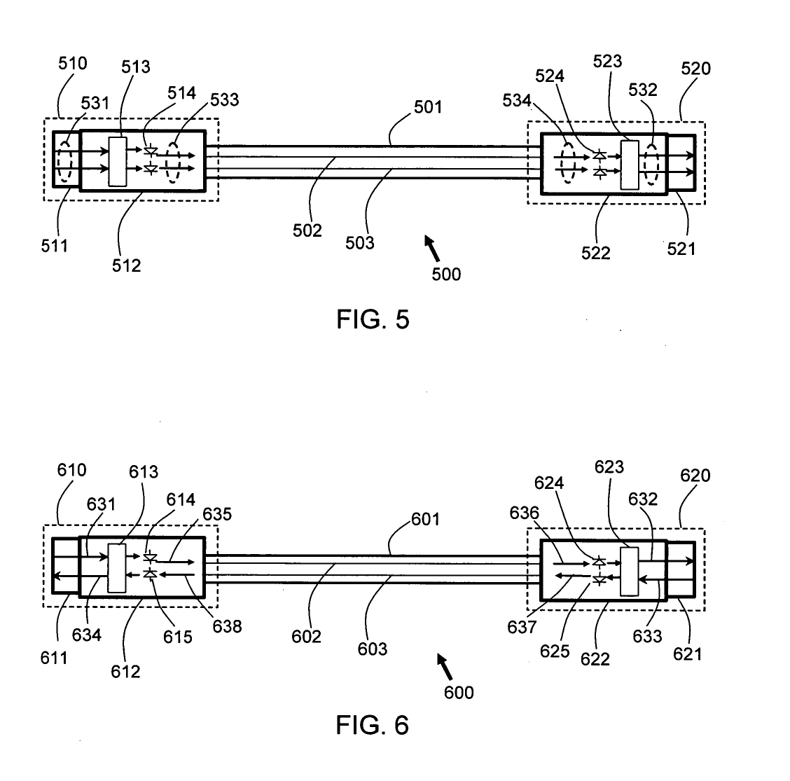

FIG. 5 is a schematic illustration of an apparatus of cable arrangement according to one embodiment of the invention. Apparatus 500 or device or cable arrangement may include multiple optical signal paths 501 integrally integrated with two terminals 510 and 520. For example, optical signal paths 501 may include an optical cable containing multiple optical fibers, for example, optical fibers 502 and 503. However, the present invention is not limited in this respect and other optical signal paths may be possible. For example, optical signal paths 501 may include multiple optical cables, which may in turn contain one or more optical fibers. Apparatus 500 may interconnect multiple electronic devices as illustrated in FIG. 1 to pass or convey or interconnect electrical signals.

According to one embodiment, terminal 510 may include an electrical interface 511 and an E/O conversion module 512. Terminal 520 may include an electrical interface 521 and an O/E conversion module 522. Terminal 510 may receive multiple electrical signals, for example, signals 531 from a first electronic device at a first location (FIG. 1) via electrical interface 511 and convert signals 531 into multiple optical signals, for example, optical signals 533 inside E/O conversion module 512 by modulating multiple light sources 514, for example, an array of laser-diodes. Optical signals 533 may propagate along multiple optical fibers 502 and 503 of optical signal paths 501, and reach terminal 520 as optical signals 534. Inside O/E conversion module 522 of terminal 520, optical signals 534 may be converted back into electrical signals 532 by, for example, an array of photon-detectors 524. Electrical signals 532, which correspond to electrical signals 531, may be transferred or coupled to a second electronic device at a second location (FIG. 1) via electrical interface 521. The first and second locations may be separated by, for example, three (3) feet, six (6) feet, or more than nine (9) feet. According to one embodiment, signal conditioners 513 and 523, of module 512 and 522 respectively, may be used to boost the power levels of electrical signals 531 and 532. However, the invention is not limited in this respect and signal conditioners 513 and 523 may be optional.

FIG. 6 is a schematic illustration of an apparatus of cable arrangement according to another embodiment of the invention. Apparatus 600 or device or cable arrangement may include multiple optical signal paths 601 terminated or integrally integrated at the end points with two terminals 610 and 620. Optical signal paths 601 may include multiple optical fibers, for example, optical fibers 602 and 603 being confined within, for example, a single optical cable or in multiple optical cables. Other grouping of optical fibers and other physical media of optical signal paths may be possible. Apparatus 600 may be connected to multiple electrical and/or electronic devices to interconnect or convey or transfer electrical signals among the multiple devices.

According to one embodiment of the invention, terminal 610 may include, for example, a connectorized electrical interface 611 and an O/E and E/O conversion module 612 or mechanism. Terminal 620 may include, for example, a connectorized electrical interface 621 and an O/E and E/O conversion module 622 or mechanism. Terminal 610 may receive at least one electrical signal, for example, signal 631 from an external signal port (FIG. 1) via interface 611. Electrical signal 631 may be converted into an optical signal 635 inside module 612 through modulation of a light source 614, for example, an LD or LED. Optical signal 635 may be coupled to propagate along, for example, optical fiber 602 towards terminal 620. In addition, module 612 may receive at least one optical signal 638 from, for example, optical fiber 603 and convert optical signal 638 into an electrical signal 634 through, for example, a photon-detection process by a photon-detector 615. Photon-detector 615 may be for example a PIN-PD or APD. Electrical signal 634 may then be coupled or transferred or passed, via electrical interface 611, to the external signal port from where electrical signal 631 is received. According to one embodiment, a signal conditioner 613 may be used optionally to boost the power levels of input and output electrical signals 631 and 634.

According to one embodiment, terminal 620 may receive an electrical signal 633 from another signal port via electrical interface 621 and module 622 inside terminal 620 may convert electrical signal 633 into an optical signal 637 through modulation of a light source 625, for example, an LD or LED. Optical signal 637 may be coupled to propagate along, for example, optical fiber 603 towards terminal 610. In addition, module 622 may receive at least one optical signal 636 from, for example, optical fiber 602 and convert optical signal 636 into an electrical signal 632 through a photon-detection process by a photon-detector 624. Photon-detector 624 may be a PIN-PD or APD. Electrical signal 632 may then be coupled or transferred or passed, via electrical interface 621, to the signal port where electrical signal 633 is received. According to one embodiment, a signal conditioner 623 may be used optionally to boost the power levels of output and input electrical signals 632 and 633.

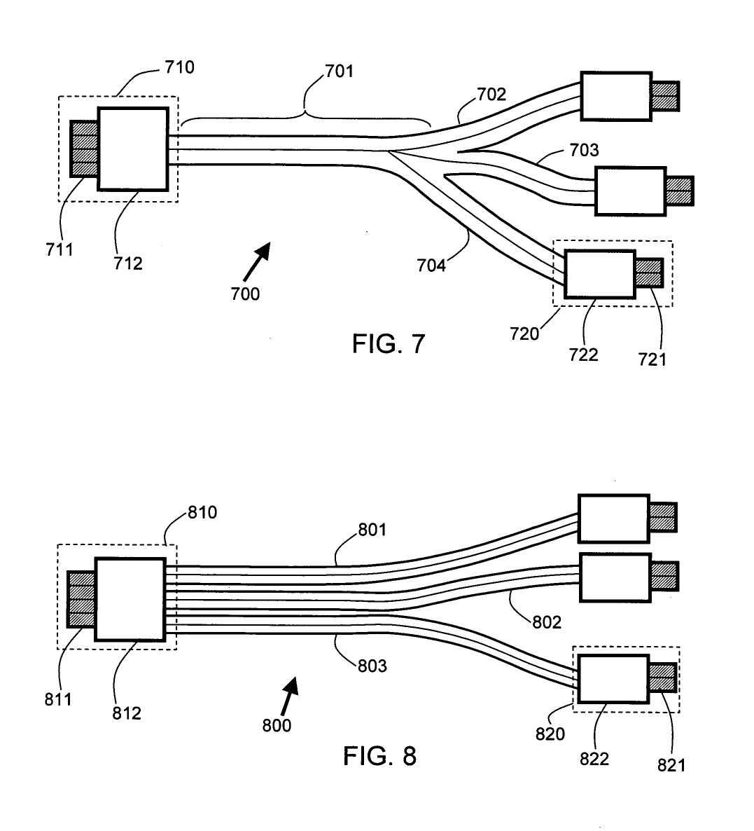

FIG. 7 is a schematic illustration of an apparatus of cable arrangement according to one embodiment of the invention. Apparatus 700 or device or cable arrangement may include multiple optical signal paths, for example, optical signal paths 702, 703, and 704. Optical signal paths 702, 703, and 704 may share, according to one embodiment, at least one section of their optical signal paths, for example, section 701, and have their end points integrally integrated with or terminated at multiple terminals. For example, section 701 may be a part or a section of optical signal path 704, and optical signal path 704 may be integrally integrated with terminal 710 at one end and with terminal 720 at the other end. Section 701 may be referred to hereinafter as an optical signal path as well. Other numbers of optical signal paths may share other numbers of sections of their optical signal paths. Apparatus 700 may be used in interconnecting electrical and/or electronic signals among multiple electronic devices.

Terminal 710 may include, for example, an electrical interface 711 and a module 712 that may include E/O and/or O/E conversion mechanisms. Terminal 710 may, for example, receive a first set, hereinafter a set includes one, of electrical signals from an electrical or electronic device (FIG. 1) via electrical interface 711, convert the electrical signals by the E/O conversion mechanism into one or more corresponding optical signals inside module 712, combine or multiplex the optical signals to become a first WDM optical signal, and couple or transmit the first WDM optical signal to propagate initially along optical signal path 701. In a reverse direction, terminal 710 may receive a second WDM optical signal, from optical signal path 701. The second WDM optical signal may be divided or de-multiplexed into multiple optical signals, for example, of different wavelengths. The multiple optical signals may be converted inside module 712 by the O/E conversion mechanism into their corresponding electrical signals, or a second set of electrical signals, and transferred or passed or coupled to the electrical or electronic device, via electrical interface 711, where the first set of electrical signal is received.

According to one embodiment of the present invention, the first WDM optical signal coupled by terminal 710 to optical signal path 701 may continue to propagate, and at the end of the shared section 701 the first WDM optical signal may be de-multiplexed or divided into multiple optical signals, which may have the same or different wavelength, to propagate either jointly or separately in optical paths 702, 703, and 704. The de-multiplexing or division of the first WDM optical signal from optical path 701 to optical paths 702, 703, and 704 may be dependent on wavelengths of each individual optical signal. However, the invention is not limited in this respect and the de-multiplexing or division may be based on, for example, power of the optical signals. For example, a same optical signal may be divided into two signals to propagate, for example, in optical path 702 and 704. An optical signal propagating along optical path 704, for example, may reach terminal 720 and may then be converted back into an electrical signal by an O/E conversion mechanism inside module 722, and transferred or coupled or transmitted to an external electronic device via an electrical interface 721 of terminal 720.

According to one embodiment of the invention, terminal 720, and other terminals of optical signal paths 702 and 703, may receive one or more electrical signals via their respective electrical interfaces, and convert the electrical signals inside their E/O and/or O/E modules into optical signals, and transmit or couple the optical signals along their respective optical signal paths 702, 703, and 704, via shared optical signal path 701, towards terminal 710. Terminal 710 may then convert the optical signals into their respective electrical signals, which may correspond to their original electrical signals received at the other ends of their respective optical signal paths, and transferred or coupled or conveyed to an external electronic device via electrical interface 711.

FIG. 8 is a schematic illustration of an apparatus of cable arrangement according to another embodiment of the invention. Apparatus 800 or device or cable arrangement may include multiple optical signal paths 801, 802, and 803. Optical signal paths 801, 802, and 803 may be optical cables of optical fibers. One of the terminal points of optical signal paths 801, 802, and 803 may be terminated at an electrical terminal 810. The other terminal points of optical signal paths 801, 802, and 803 may be terminated separately at separated terminals. For example, the other terminal point of optical signal path 803 may be terminated at a terminal 820. Apparatus 800 may interconnect signals, which may be electrical signals, among multiple devices, which may be electrical and electronic devices.

According to one embodiment of the invention, terminal 810 may include, for example, an E/O and/or O/E module 812 and an electrical interface 811 that may include a connector. Terminal 820 may include, for example, an E/O and/or O/E conversion module 822 and an electrical interface 821 that may include a connector. Terminal 810 may receive one or more electrical signals from an electronic device via electrical interface 811, convert the electrical signals into multiple optical signals inside module 812, and transmit or couple or propagate the optical signals along optical paths 801, 802, and/or 803. For example, an optical signal may be received by terminal 820. Module 822 of terminal 820 may convert the optical signal received back into an electrical signal, which may correspond to the original electrical signal received at terminal 810, and pass or transfer the electrical signal to an external electronic device via electrical interface 821. Terminal 810 may also receive one or more optical signals via optical paths 801, 802, and/or 803. For example, an optical signal may propagate along optical signal path 803 from terminal 820 to terminal 810.

FIG. 9 is a block diagram illustration of a terminal configuration according to one embodiment of the invention. Terminal 900 may include at least an electrical interface 911, which may be an electrical connector as described above, and a module 912 having included an E/O (916) and/or an O/E (920) conversion mechanism therein. According to one embodiment of the invention, module 912 may be pigtailed to one or more optical signal paths 902 and 903. Optical signal paths 902 and 903 may be, for example, optical fibers enclosed inside one optical cable 901. However, the invention is not limited in this respect and optical fibers 902 and 903 may be enclosed in separate optical cables.

According to one embodiment, terminal 900 may receive an electrical signal 921 from an external electronic device, as shown in FIG. 1, via interface 911. Inside module 912, electrical signal 921 may first be boosted by a signal conditioner 915, and then converted into an optical signal 917 by E/O conversion module 916. Optical signal 917 may be launched or coupled to propagate along optical signal path 903 towards another terminal (not shown). According to another embodiment, an optical signal 919 may be received by module 912 via an optical signal path 902. O/E conversion module 920 may convert optical signal 919 into an electrical signal 922. Optionally, electrical signal 922 may be boosted in power by signal conditioner 915 before being coupled or transferred to the external electronic device from where electrical signal 921 is received via interface 911.

According to one embodiment of the invention, a power unit 914 inside module 912 may receive electrical energy or a power supply, via electrical interface 911 through a media 913 such as for example a wire, from an external power source. The power supply or electrical energy may be a direct current (DC). However the invention is not limited in this respect and power supplies other than a DC power supply may be used. If other forms of power supplies are used, power unit 914 may provide transformation of the power supplies into a DC power supply to be used by other components or devices inside module 912, for example, signal conditioner 915, E/O module 916 and/or O/E module 920.

FIG. 10 is a block diagram illustration of a terminal configuration according to another embodiment of the invention. Terminal 1000 may include an electrical interface 1011, which may be an electrical connector as described above, and a module 1012 included therein an E/O conversion mechanism or module 1016 and/or an O/E conversion mechanism or module 1020. According to one embodiment, module 1012 may be pigtailed by an optical signal path 1001, which for example may be an optical fiber 1002 enclosed inside an optical cable. Optical fiber 1002 may convey or transfer optical signals in both directions.

According to one embodiment, terminal 1000 may receive an electrical signal 1021 via connector 1011. The power of signal 1021 may be boosted by a signal conditioner 1015, and then converted into an optical signal 1017 by E/O conversion module 1016. Optical signal 1017 may then propagate along optical signal path 1002 via a multiplexer/demultiplexer (MUX/DEMOX) module 1018. According to another embodiment, an optical signal 1019 may be received by module 1012 via optical signal fiber 1002 and MUX/DEMUX module 1018. O/E conversion module 1020 may convert optical signal 1019 into an electrical signal 1022. Electrical signal 1022 may be power boosted by signal conditioner 1015 before being passed or coupled or transferred to, via connector 1011, an external electronic device from which electrical signal 1021 is received. According to one embodiment of the invention, a power unit 1014 may receive a power supply, via electrical interface 1011 through a media such as a wire 1013, from an external power source, and provide the power supply or energy received, which may be a DC power supply, to signal conditioner 1015, E/O module 1016, and/or O/E module 1020.

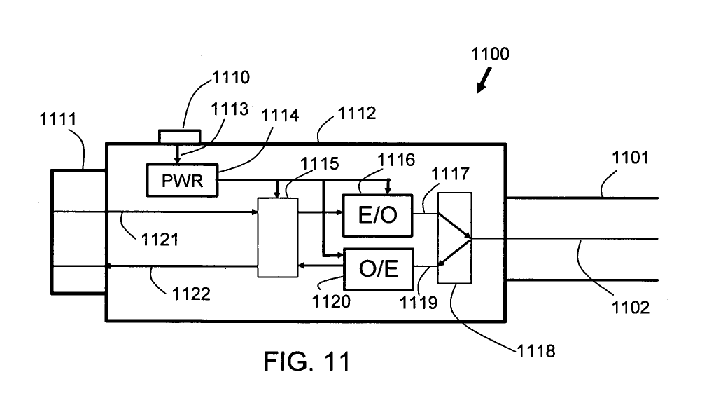

FIG. 11 is a block diagram illustration of a terminal configuration according to yet another embodiment of the invention. Terminal 1100 may include an electrical interface 1111, which may be an electrical connector as described above, and a module 1112 having an E/O (1116) and/or an O/E (1120) conversion mechanism. According to one embodiment, module 1112 may be pigtailed by an optical signal path, for example, an optical fiber 1102 inside an optical cable 1101. Optical fiber 1102 may transfer or convey optical signals in one or in both directions.

According to one embodiment, an electrical signal 1121 may be received at connector 1111, boosted optionally in power by a signal conditioner 1115, and converted into an optical signal 1117 by E/O conversion module 1116. According to one embodiment, via optical signal path 1102, an optical signal 1119 may be received by module 1112. O/E conversion module 1120 may convert optical signal 1119 into an electrical signal 1122, which may be optionally boosted by signal conditioner 1115 and transferred or coupled to an electronic device outside, from where electrical signal 1121 is received, via connector 1111.

According to one embodiment of the invention, a power unit 1114 may provide electrical energy to signal conditioner 1115, to E/O module 1116, and/or to O/E module 1120. Power unit 1114 may receive a power supply or electrical energy from an external power source (not shown) through an interface or a connectorized interface 1110 via an electrical path 1113, for example, a wire. However, the invention is not limited in this respect. Power unit 1114 may include a battery to receive electrical power or energy to be supplied to other devices or components inside module 1112 such as signal conditioner 1115, E/O module 1116, and/or O/E module 1120.

FIG. 12 is a block diagram illustration of a terminal configuration according to yet another embodiment of the invention. Terminal 1200 may include an electrical connector 1211 and a module 1212 having electro-optic conversion mechanisms. According to one embodiment, module 1212 may be pigtailed by an optical signal path, e.g., an optical fiber 1202 inside an optical cable 1201. Optical fiber 1202 may transport or carry or convey optical signals in one or in both directions.

According to one embodiment, terminal 1200 may receive an electrical signal 1221 via connector 1211. A signal conditioner 1215 may boost electrical signal 1221 in power, and converted electrical signal 1221 into an optical signal 1217 by an E/O conversion module 1216. According to one embodiment, via optical signal path or optical fiber 1202, an optical signal 1219 may be received by module 1212 via a MUX/DEMUX module 1218, converted by an O/E conversion module 1220 into an electrical signal 1222, boosted in power and/or conditioned in shape by signal conditioner 1215, and transmitted or coupled or transferred to an external signal port, via electrical connector 1211, from where electrical signal 1221 is received. Outgoing optical signal 1217 and incoming optical signal 1219 may be multiplexed by MUX/DEMUX module 1218.

According to one embodiment of the invention, a power unit 1214 may provide electrical power supply or energy to, for example, signal conditioner 1215, E/O module 1216, and/or O/E module 1220. The electrical energy may be received from an external power source via interface 1210. However, the invention is not limited in this respect and the power source may be received via electrical interface 1211. In addition, power unit 1214 may provide a power supply or electrical energy via an electrical path 1213 to a remote terminal, which may be a terminal at the other end of optical signal path 1201, through an electrical wire 1230. Electrical wire 1230 may be retained or confined, alongside with optical fiber 1202, inside optical cable 1201.

FIG. 13 is a block diagram illustration of a terminal configuration according to another embodiment of the invention. Terminal 1300 may include an electrical interface 1311 and a module 1312. According to one embodiment, module 1312 may be pigtailed, for example, by an optical fiber 1302 inside an optical cable 1301. Optical fiber 1302 may transport or carry or convey optical signals, in one or in both directions.

According to one embodiment, terminal 1300 may receive an electrical signal 1321 via electrical connector 1311. A signal conditioner 1315 may boost electrical signal 1321 in power, and converted electrical signal 1321 into an optical signal 1317 by an E/O conversion module 1316. According to one embodiment, via optical signal path 1302, an optical signal 1319 may be received by module 1312 via a MUX/DEMUX module 1318, converted by an O/E conversion module 1320 into an electrical signal 1322, after boosted in power and/or conditioned in shape by signal conditioner 1315 and transmitted or coupled or transferred to an external signal port, via connector 1311, from where electrical signal 1321 is received. Outgoing optical signal 1317 and incoming optical signal 1319 may be multiplexed at MUX/DEMUX module 1318.

According to one embodiment of the invention, a power unit 1313 may provide an electrical power supply or energy to other components or devices inside module 1312 such as, for example, signal conditioner 1315, E/O module 1316, and/or O/E module 1320, via an electrical path 1314. The electrical power supply or energy may be received, via an electrical wire 1330 coming alongside with optical fiber 1302 within optical cable 1301, from a remote terminal, for example terminal 1200 (FIG. 12), at the other end of optical path or cable 1301.

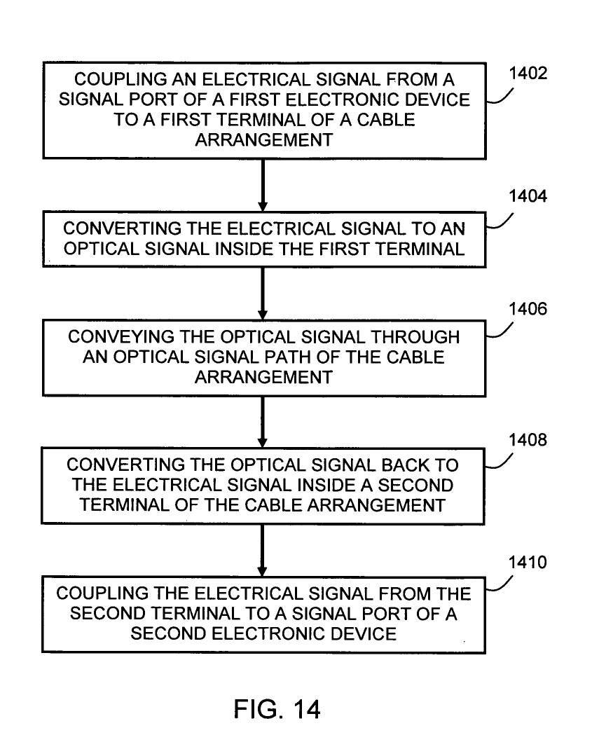

FIG. 14 is a flowchart illustration of a method for passing an electrical signal from a first to a second electronic device according to one embodiment of the invention.

According to one embodiment of the invention, the method may, at operation 1402, coupling the electrical signal from a signal port of the first electronic device to a first terminal of a cable arrangement or apparatus. The coupling may be through an electrical interface or a connectorized interface. At operation 1404, the electrical signal may be converted to an optical signal inside the first terminal through an electrical-to-optical conversion mechanism or an E/O module. For example, the mechanism may apply a light source such as a laser-diode to generate an optical signal corresponding to the input electrical signal. At operation 1406, the generated optical signal may be conveyed through or propagate along an optical signal path of the cable arrangement to a second terminal. The cable arrangement may be, for example, one or more optical fibers. The optical fiber may be a single mode fiber a multi-mode fiber, and may be a silica based fiber or a plastic fiber or any other fibers made with materials able to transport lights or optical signals. At operation 1408, the optical signal may be converted back into an electrical signal, inside the second terminal, which may correspond to and represent or carry the same information such as voice, image, or data information as, the original electrical signal received at the first terminal. At operation 1410, the re-generated electrical signal may be transmitted or coupled or transferred to a signal port of the second electronic device via an electrical interface of the second terminal. The first and second electronic devices may be in general different electronic devices but the invention is not limited in this respect and the first and second electronic device may be a same device having multiple electrical signal ports.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. An apparatus for interconnecting an electrical signal from a first electronic device to a second electronic device, the apparatus comprising:
at least one optical signal path; and
first and second terminals integrally integrated with the optical signal path, the first and second terminals having respective first and second electrical interfaces and being separated by a distance in a range, up to the length of the optical signal path, adapted to connect the first and second electronic devices at respective first and second locations,
wherein the first terminal is adapted to receive the electrical signal from the first electronic device via the first electrical interface and to convey the electrical signal to the second terminal via the optical signal path; the second terminal is adapted to transfer the electrical signal from the first terminal to the second electronic device via the second electrical interface.

2. The apparatus of claim 1, wherein the first terminal comprises a mechanism to convert the electrical signal received from the first electronic device into an optical signal to propagate in the optical signal path.

3. The apparatus of claim 2, wherein the second terminal comprises a mechanism to convert the optical signal received from the optical signal path back into the electrical signal to be transferred to the second electronic device.

4. The apparatus of claim 3, wherein the mechanism of converting the electrical signal into the optical signal comprises a light source and the mechanism of converting the optical signal into the electrical signal comprises a photon-detector.

5. The apparatus of claim 1, wherein at least one of the electrical interfaces is adapted to receive a power supply used for operation of at least one of the terminals.

6. The apparatus of claim 1, wherein at least one of the electrical interfaces of the terminals comprises an electrical connector being adapted to engage electrically with one of the first and second electronic devices.

7. The apparatus of claim 1, wherein the optical signal path comprises an optical cable containing therein at least one optical fiber.

8. The apparatus of claim 1, further comprising an electrical wire conveying the electrical power supply from one of the first and second terminals that receives the electrical power supply through the electrical interface to the other terminal.

9. An apparatus comprising:
at least one optical signal path; and
at least first and second terminals integrally integrated with the optical signal path, the first and second terminals having first and second electrical interfaces respectively,
wherein the first terminal is adapted to receive at least first and second electrical signals from a first electronic device at a first location via the first electrical interface; and the second terminal is adapted to receive at least one of the first and second electrical signals from the first terminal via the optical signal path, and to transfer the received electrical signal to a second electronic device at a second location via the second electrical interface.

10. The apparatus of claim 9, wherein the first terminal comprises a mechanism to convert said first and second electrical signals received from said first electronic device into first and second optical signals respectively, and to cause at least one of the first and second optical signals to propagate in the optical signal path.

11. The apparatus of claim 9, wherein the second terminal comprises a mechanism to convert one of the first and second optical signals received via the optical signal path into the received electrical signal to be transferred to said second electronic device.

12. The apparatus of claim 9, wherein at least one of the terminals receives an electrical power supply from the electrical interface of the terminal.

13. The apparatus of claim 9, wherein at least one of the terminals receives an electrical power supply from the other terminal via an electrical wire.

14. The apparatus of claim 9, wherein said optical signal path is a first optical signal path, further comprising a second optical signal path having a first end point terminated at the first terminal and a second end point terminated at a third terminal having a third electrical interface,
wherein the first terminal comprises a mechanism to convert said first and second electrical signals received from said first electronic device into first and second optical signals to propagate in the first and second optical signal paths; the second terminal comprises a mechanism to convert said first optical signal received from the first optical signal path back into said first electrical signal; and the third terminal comprises a mechanism to convert said second optical signal received from the second optical signal path back into said second electrical signal to be transferred to a third electronic device at a third location via the third electrical interface.

15. The apparatus of claim 14, wherein at least a section of the first optical signal path overlaps with a portion of the second optical signal path.

16. An apparatus comprising:
at least one optical signal path; and
at least first and second terminals integrally integrated with the optical signal path, the first and second terminals having first and second electrical interfaces respectively,
wherein the first terminal is adapted to receive a first electrical signal from a first electronic device at a first location via the first electrical interface and to transfer a second electrical signal to the first electronic device; and the second terminal is adapted to transfer at least the first electrical signal received from the first terminal via the optical signal path to a second electronic device at a second location via the second electrical interface.

17. The apparatus of claim 16, wherein the first terminal comprises a mechanism to convert said first electrical signal received from said first electronic device into a first optical signal to propagate in the optical signal path and to convert a second optical signal received from the optical signal path back into the second electrical signal to be transferred to the first electronic device.

18. The apparatus of claim 16, wherein the second terminal comprises a mechanism to convert a first optical signal received from the optical signal path back into the first electrical signal to be transferred to said second electronic device and to convert the second electrical signal received from said second electronic device into a second optical signal to propagate in the optical signal path.

19. The apparatus of claim 16, wherein at least one of the terminals receives an electrical power supply from an external power source via one of the electrical interfaces.

20. The apparatus of claim 16, wherein said optical signal path is a first optical signal path, further comprising a second optical signal path having a first end point terminated at the first terminal and a second end point terminated at a third terminal having a third electrical interface;
wherein the first terminal comprises a mechanism to convert said first electrical signal received from said first electronic device into a first optical signal to propagate in the first optical signal path and to convert a second optical signal from the second optical signal path back into the second electrical signal to be transferred to the first electronic device; the second terminal comprises a mechanism to convert said first optical signal received from the first optical signal path back into said first electrical signal to be transferred to the second electronic device; and the third terminal comprises a mechanism to convert said second electrical signal received from a third electronic device at a third location via the third electrical interface into the second optical signal to propagate in the second optical signal path.
